(19) United States
(12) Patent Application Publication
(10) Pub. No.: US 2006/0271625 A1
(43) Pub. Date: Nov. 30, 2006

(54) Selective monitoring and publishing of discussion threads with membership linking

(75) Inventor: Alexander Kordun, West Roxbury, MA (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/136,964

(22) Filed: May 25, 2005

(51) Int. Cl. G06F 15/16

(52) U.S. Cl. 709/204

(57) ABSTRACT

A method of selectively sharing a discussion thread with a user can include identifying at least one user specified by an access control structure associated with a discussion thread in a forum and determining that the at least one user is not a member of the forum. The method further can include publishing the discussion thread to the user.

### BACKGROUND

1. Field of the Invention

The present invention relates to forums or discussion groups and, more particularly, to selectively sharing discussion threads included within such forums.

2. Description of the Related Art

A forum, also referred to as a discussion group or message board, refers to a network-based application which allows member users to post commentary. Examples of forums can include, but are not limited to, Websites which implement discussion groups, whether on the Internet or in an intranet environment, as well as predecessors to Website implementations known as bulletin boards. A forum application allows a community of users to meet in a virtual meeting place provided by the application. Within this virtual meeting place, members of the community can post messages which, when published to the forum, become accessible to other members of the community.

Within a forum, postings typically are listed in chronological or reverse chronological order. Still, when a message is posted in a forum, members of the forum have an opportunity to respond to the posting with an answer or other commentary. Messages that have been posted, or published, to the forum, can be linked to form what is referred to as a discussion thread. A discussion thread, in general, refers to a collection of messages and replies which are direct and indirect children of a particular message or post to the forum. Oftentimes, the messages relate to a specific topic or subject, though this need not be the case. Rather than presenting all messages of the forum in chronological order, a discussion thread typically presents only those messages, i.e. posted messages and replies, which belong to the discussion thread. Still, messages of the discussion thread can be sorted according to date, time, sender, or the like. The discussion thread often presents messages such that replies are listed directly beneath the message to which the reply was provided.

Conventional forums require users to become members before participating in a discussion. When a message is posted to the forum, the message is public in the sense that any member of the forum can view and respond to the message. Thus, if a user wishes to follow discussion threads from a plurality of different forums, that user first must become a member of each forum. The user then can log into each forum to view the discussion threads of interest.

It would be beneficial to provide a technique for managing discussion threads such that individual discussion threads can be selectively shared with, or published to, various users and/or user groups.

### SUMMARY OF THE INVENTION

The present invention provides a solution for selectively allowing a user or class of user to participate in a discussion thread from a forum regardless of whether the user is a member of that forum. One embodiment of the present invention can include a method of selectively sharing a discussion thread with a user. The method can include identifying one or more users specified by an access control structure associated with a discussion thread in a forum, determining that the user(s) are not members of the forum, and publishing the discussion thread to the user(s).

Another embodiment of the present invention can include a method of selectively sharing a discussion thread with a user including specifying at least one user within an access control structure for a discussion thread, wherein the discussion thread is included within a forum, and sending an invite to the user(s). The method further can include adding the discussion thread to a computing environment corresponding to the user(s) such that the user(s) can access the discussion thread of the forum via the computing environment.

Yet another embodiment of the present invention can include a machine readable storage being programmed to cause a machine to perform the various steps described herein.

### BRIEF DESCRIPTION OF THE DRAWINGS

There are shown in the drawings, embodiments which are presently preferred; it being understood, however, that the invention is not limited to the precise arrangements and instrumentalities shown.

FIG. 1 is a block diagram illustrating a plurality of online forums each having one or more discussion threads which can be incorporated into a different computing environment in accordance with one embodiment of the present invention.

FIG. 2 is a pictorial view of a graphical user interface (GUI) for presenting one or more discussion threads in accordance with the inventive arrangements disclosed herein.

FIG. 3 is a flow chart illustrating a method of selectively sharing discussion threads in accordance with another embodiment of the present invention.

### DETAILED DESCRIPTION OF THE INVENTION

The present invention provides a method and apparatus for sharing discussion threads from various forums among one or more users. As used herein, a forum can refer to a virtual meeting place capable of hosting discussions where users having appropriate privileges can post messages relating to one or more different subjects or topics and/or otherwise interact. Users access the virtual meeting place via a communication network. A discussion thread, in general, refers to a collection of messages and replies which are direct and indirect children of a particular message or post to the forum. Oftentimes, the messages relate in some manner to a specific topic or subject, though this need not be the case. The messages of a discussion thread typically are linked with one another. Each forum can include one or more different discussion threads.

The following is presented as an example to better illustrate the notion of a discussion thread. A user can post a message to a forum. This message can serve as a catalyst for discussion, which may or may not relate to the content, or the subject, of the original message. In either case, the replies that are posted in response to the original message as well as the “replies to the replies” form a discussion thread with the original message serving as the root of the discussion thread. Thus, in addition to the traditional “subject” concept of a discussion thread, a discussion thread also can be viewed as a tree-like construct of messages having a single root message. With this definition in mind, it can be seen that a discussion thread also can be comprised of sub-threads which correspond to branches of messages and replies within the tree-like structure.

In accordance with the inventive arrangements disclosed herein, access control data structures can be associated with discussion threads within a forum. The access control data structures indicate which users, or groups of users, can access a given discussion thread. The users or groups of users specified in an access control data structure need not be members of the forum to which the associated discussion thread belongs. Users specified by the access control data structure are able to participate in the associated discussion thread. This allows users to participate and/or view discussion threads from one or more different forums without becoming a member of each forum or having to visit each forum.

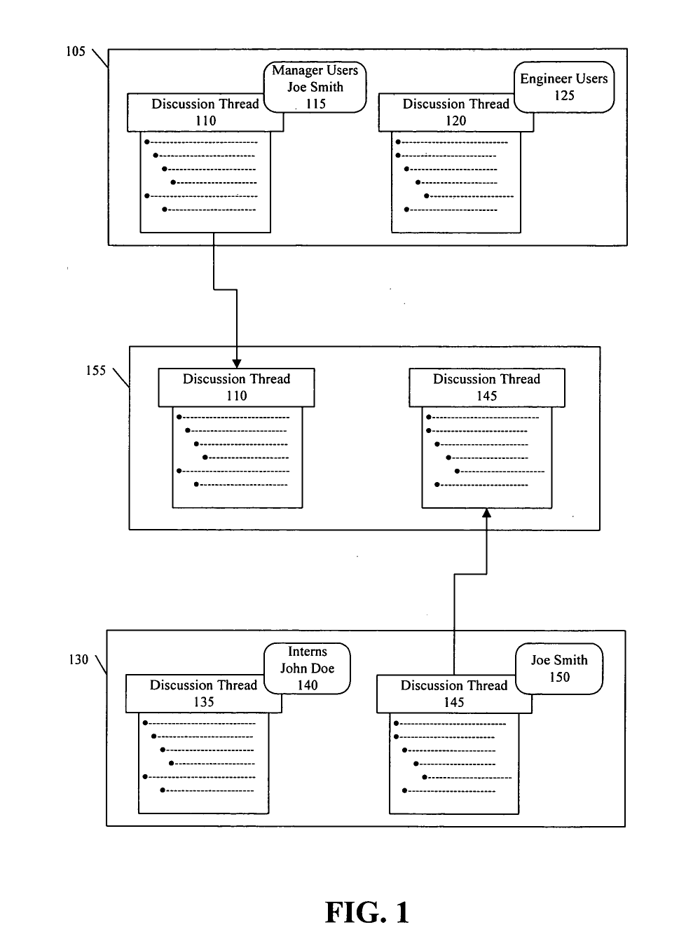

FIG. 1 is a block diagram illustrating a plurality of forums 105 and 130, each having one or more discussion threads which can be incorporated into a different forum or computing environment 155 in accordance with the inventive arrangements disclosed herein. Forums 105 and 130 each can be implemented as an application configured to provide a discussion group or virtual meeting space that is available to users over a communication network such as the Internet, the World Wide Web, an intranet, a Wide Area Network, a Local Area Network, or the like.

Each online forum can include one or more discussion threads. As shown, forum 105 can include discussion thread 110 and 120. Each discussion thread can correspond to a specific topic. That is, each message of a discussion thread can relate to a designated topic or subject. As shown, each discussion thread has been associated with an access control data structure (access control structure). Discussion thread 110 is associated with access control structure 115 and discussion thread 120 is associated with access control structure 125. Similarly, online forum 130 includes discussion threads 135 and 145. Discussion thread 135 is associated with access control structure 140 and discussion thread 145 is associated with access control structure 150.

It should be appreciated that while each thread is shown to be associated with its own access control structure, this need not be the case. In one embodiment, a single access control structure can be used within each forum to specify which users are to have access to each discussion thread that is part of that forum. If the forums are part of a larger, common computing environment, a single data structure can be used to track and/or indicate which users may access the various discussion threads from the plurality of forums.

In any case, each access control structure 115, 125, 140, and 150 defines which users, or class of user, may access the thread that is associated with that access control structure. The access control structures 115, 125, 140, and 150 can be implemented as tables, databases, or other data structures. The particular type of data structure used is not intended as a limitation of the present invention.

As discussed, conventional forums require membership in the forum to access any discussion threads contained therein. In accordance with the present invention, the rules regulating whether a user can access a discussion thread can be further specified within the access control structure associated with each discussion thread. Unlike conventional online forums, the access control structures can specify users that are not members of the forum.

Discussion thread 110 is associated with access control structure 115 which specifies that a class of users identified as manager users as well as an individual user Joe Smith can access discussion thread 110. Accordingly, any users which have an attribute within their user profile identifying the user as a manager can access discussion thread 110. Similarly, the individual user named Joe Smith can access discussion thread 110. Manager users and Joe Smith can access discussion thread 110 whether or not such users are members of online forum 105. By the same token, access control structure 125 indicates that engineer users may access discussion thread 120 whether or not such users are members of online forum 105.

Regarding online forum 130, access control structure 140 indicates that the class of users identified as interns and the individual user identified as John Doe can access discussion thread 135 whether or not such users are members of online forum 130. Similarly, access control structure 150 indicates that individual user Joe Smith may access discussion thread 145 whether or not Joe Smith is a member of online forum 130.

In one embodiment, the access control structures need only specify those users that have access to a given discussion thread, but are not members of the forum containing the discussion thread. Such can be the case as forums typically include another mechanism, such as a membership database, to regulate or determine which users are members. In another embodiment, however, access control structures can be used as the sole means of regulating access to discussion threads.

For purposes of illustration, computing environment 155 can represent a virtual workspace that is associated with individual user Joe Smith. In one embodiment, computing environment 155 can be implemented as an application or a portlet included within a larger environment such as Websphere® Portal or IBM Workplace, which are software products commercially available from International Business Machines Corporation of Armonk, N.Y.

As shown, computing environment 155 includes discussion thread 110 from forum 105 and discussion thread 145 from forum 130. Computing environment 155 illustrates that although the user Joe Smith is not a member of forum 105 or forum 130, the user can access discussion threads 110 and 145 as indicated by access control structures 115 and 150 respectively.

Discussion threads 110 and 145 can be accessed by the designated user(s), in this case Joe Smith, via computing environment 155. As such, user Joe Smith does not have to log into or visit online forums 105 or 130 to participate in discussion threads 110 or 145 as such activities can be performed via computing environment 155. It should be appreciated that while non-members can be selectively granted access to discussion threads, members of each respective forum can continue to access and/or participate in discussion threads in a conventional manner, via a portlet, or the like. The access control structures, however, allow particular discussion threads of the online forums to be selectively published to non-member users and/or classes of users as the case may be.

Though not shown, it should be appreciated that other users such as John Doe, or classes of users such as interns or engineers, each can be provided with computing environments through which discussion threads can be published or otherwise made available. In one embodiment, each group or class of user can be provided with a computing environment or interface for accessing or participating in discussion threads available to that group. In another embodiment, each individual user can view discussion threads through his or her own computing environment as illustrated. Thus, if individual user John Doe belonged to the manager class of user, John Doe could access discussion threads 110 and 135 via his computing environment.

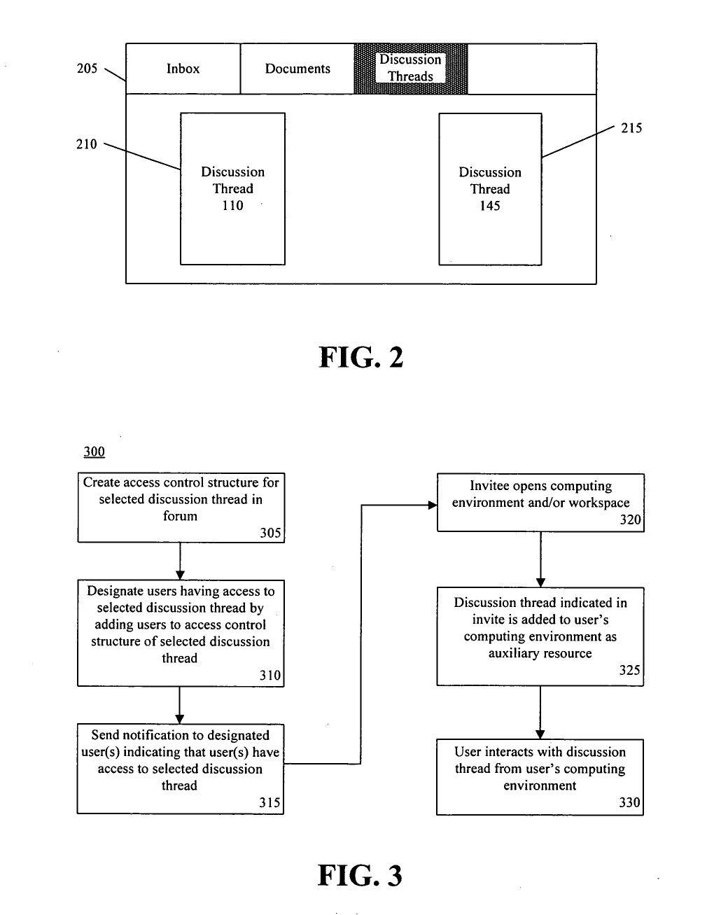

FIG. 2 is a pictorial view of a graphical user interface (GUI) 205 for presenting one or more discussion threads in accordance with the inventive arrangements disclosed herein. The GUI 205 can be displayed as part of a computing environment as previously described. For purposes of illustration, GUI 205 will be described in the context of the examples discussed in FIG. 1, where an individual user known as Joe Smith accesses a personalized computing environment.

As shown, a discussion thread tab of GUI 205 is selected. Accordingly, GUI 205 presents those discussion threads in which user Joe Smith is able to participate. With reference to FIG. 1, GUI 205 presents view 210 showing discussion thread 110 and view 215 showing discussion thread 145. Each view can include a listing of the messages of the discussion thread as well as any necessary controls for reading messages, posting messages, searching for messages, and the like. As noted with reference to FIG. 1, user Joe Smith is not a member of the forums that contain discussion threads 110 and 145. As user Joe Smith was added to the access control structures for discussion threads 110 and 145, however, user Joe Smith as able to view and participate in each discussion thread presented within the GUI 205 of the user's personal workspace.

FIG. 2 illustrates an embodiment where each discussion thread can be presented within GUI 205. In another embodiment, a reference to each discussion thread can be presented. Thus, rather than showing a discussion thread view including posted messages and controls for participating in the discussion thread, a reference to the discussion thread can be shown. Once the reference, i.e. a link or a button, is selected, another GUI can be presented which includes a view of the selected discussion thread.

FIG. 3 is a flow chart illustrating a method 300 of selectively sharing discussion threads in accordance with another embodiment of the present invention. Method 300 can begin in step 305 where an access control structure can be created for, and associated with, a discussion thread within a forum. For example, it may be useful for a manager to access a discussion thread located within an online forum for a team that is supervised by the manager. The online forum can be used by the development team to discuss one or more issues or topics relating to the team's development tasks. As noted, each topic within the online forum can represent an individual discussion thread. Continuing with the example, within the forum, an access control structure can be created for a discussion thread that pertains to the resolution of a software defect.

In step 310, one or more users that are not members of the forum that includes the selected discussion thread, i.e. the discussion thread pertaining to the resolution of the software defect, can be added to the access control structure of that discussion thread. Users can be specified on an individual basis or by class or role. In one embodiment, users can be selected from a directory or listing of users and/or classes of users. The listing of users can be separate from, or independent of, the membership database for the forum. In any case, one or more users can be specified from the directory whether such users are members of the forum or not.

Continuing with the example, the manager of the software team can be added to the access control structure for the thread relating to the software defect. In this example, the manager is not a member of the online forum that includes the discussion thread. The online forum may, for instance, only be open to members of the development team.

In step 315, responsive to adding the designated user or users to the access control structure of the selected discussion thread, a notification can be sent to each designated user. That is, an invitation can be sent to each user specified by the access control structure. The invitation can be an electronic mail, an instant message, or the like, which indicates that the user has been provided with the ability to participate in the selected discussion thread. Accordingly, an electronic message can be sent to the manager indicating that he or she has been invited to the discussion thread relating to the software defect.

In step 320, the user that received the invitation for the selected discussion thread, referred to as the invitee, can open a workspace, personal online forum, or other type of computing environment. It should be appreciated that the computing environment that is opened in step 320 can be considered different, or exclusive, from the forum that included the discussion thread. For example, the manager can open a workspace environment as illustrated in FIG. 2. This environment can be personalized for the manager, i.e. include an electronic mail inbox, or other objects, such as discussion threads, associated with the manager.

In step 325, the discussion thread that was specified in the invite can be added to the computing environment of the user, or invitee. The addition of the discussion thread can be performed by adding a link to the discussion thread within the user's computing environment. Alternatively, a software component such as a module or portlet can be included within the user's computing environment which provides an interface for viewing and/or participating in the discussion thread.

Referring to the example, the manager can select an option from within the invite or from within the computing environment which causes the discussion thread to be imported or shown within an interface of the manager's computing environment. Once added, the manager can view a reference such as a link to the discussion thread or view the discussion thread itself from within the computing environment. The discussion thread or reference to the discussion thread can be made to appear similar to other threads within the computing environment, whether such threads are from forums to which the user is a member or not. Alternatively, the discussion thread, or reference thereto, can be visually distinguished from discussion threads from forums to which the user is a member.

In step 330, the user can interact with the discussion thread. This interaction can be performed from the user's own computing environment. Thus, the manager can participate in the discussion thread relating to the software defect from the manager's personal computing environment. The manager need not join the forum that contained the discussion thread or access that forum.

The method 300 has been provided for purposes of illustration only and is not intended as a limitation of the present invention. As such, it should be appreciated that one or more steps can be performed in varying order without departing from the spirit of the invention. For example, in one embodiment, the invitee need not open his or her computing environment prior to adding the discussion thread to that environment.

The present invention provides a technique for selectively sharing discussion threads among users. In accordance with the inventive arrangements disclosed herein, discussion threads from various forums can be selectively published to users regardless of whether those users are members of the forum(s) containing the discussion threads. Access for discussion threads can be granted on a per discussion thread basis for individual users and/or for classes of users. The present invention allows users to access discussion threads from one or more different forums from a centralized interface without the need to visit the forum containing each discussion thread.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program, software application, and/or other variants of these terms, in the present context, mean any expression, in any language, code, or notation, of a set of instructions intended to cause a system having an information processing capability to perform a particular function either directly or after either or both of the following: a) conversion to another language, code, or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of selectively sharing a discussion thread with a user comprising:
identifying at least one user specified by an access control structure associated with a discussion thread in a forum;
determining that the at least one user is not a member of the forum; and
publishing the discussion thread to the at least one user.

2. The method of claim 1, said publishing step further comprising sending an invite to the at least one user indicating that the at least one user has been granted access to the discussion thread.

3. The method of claim 1, further comprising presenting the discussion thread of the forum within an interface of a computing environment corresponding to the at least one user.

4. The method of claim 3, wherein the at least one user accesses the discussion thread via the interface of the computing environment.

5. The method of claim 1, further comprising creating the access control structure for the discussion thread.

6. The method of claim 1, further comprising:
selecting the at least one user from a plurality of users; and
adding the at least one user to the access control structure for the discussion thread.

7. The method of claim 6, wherein the at least one user is selected from a directory of users which is independent of a membership directory for the forum.

8. A method of selectively sharing a discussion thread with a user comprising:
specifying at least one user within an access control structure for a discussion thread, wherein the discussion thread is included in a forum;
sending an invite to the at least one user; and
adding the discussion thread to a computing environment corresponding to the at least one user, wherein the at least one user can access the discussion thread of the forum via the computing environment.

9. The method of claim 8, wherein the access control structure specifies users that are not members of the forum but are permitted access to the discussion thread of the forum.

10. The method of claim 8, further comprising determining that the at least one user is not a member of the forum.

11. The method of claim 8, further comprising:
selecting the at least one user from a plurality of users; and
including the at least one user within the access control structure for the discussion thread.

12. The method of claim 11, wherein the at least one user is selected from a directory of users which is independent of a membership directory for the forum.

13. The method of claim 8, wherein the forum includes at least one additional discussion thread having an associated access control structure that does not specify the at least one user, said method further comprising restricting the at least one user from accessing the at least one additional discussion thread from within the computing environment.

14. The method of claim 8, wherein the at least one user comprises a class of users.

15. A machine readable storage, having stored thereon a computer program having a plurality of code sections executable by a machine for causing the machine to perform the steps of:
specifying at least one user within an access control structure for a discussion thread, wherein the discussion thread is included within a forum;
sending an invite to the at least one user; and
adding the discussion thread to a computing environment corresponding to the at least one user, wherein the at least one user can access the discussion thread of the forum via the computing environment.

16. The machine readable storage of claim 15, wherein the access control structure specifies users that are not members of the forum but are permitted access to the discussion thread of the forum.

17. The machine readable storage of claim 15, further comprising determining that the at least one user is not a member of the forum.

18. The machine readable storage of claim 15, further comprising:
selecting the at least one user from a plurality of users; and
including the at least one user within the access control structure for the discussion thread.

19. The machine readable storage of claim 18, wherein the at least one user is selected from a directory of users which is independent of a membership directory for the forum.

20. The machine readable storage of claim 15, wherein the forum includes at least one additional discussion thread having an associated access control structure that does not specify the at least one user, said method further comprising restricting the at least one user from accessing the at least one additional discussion thread from within the computing environment.
